(19) United States
(12) Patent Application Publication
(10) Pub. No.: US 2010/0016019 A1
(43) Pub. Date: Jan. 21, 2010

(54) Communication and Operation Using Wireless Peripherals

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 12/174,782

(22) Filed: Jul. 17, 2008

(51) Int. Cl. H04M 1/00

(52) U.S. Cl. 455/557

(57) ABSTRACT

Communication with a wireless peripheral is carried out by communicating with the peripheral and taking at least one action to warn and/or prevent the user from moving during a time that they are using the peripheral.

### BACKGROUND

Some different devices have the ability to communicate wireless with various kinds of other devices. PDAs, computers and cellular phones may have wireless capability via WiFi, Bluetooth, wireless USB, and other capabilities. The wireless capability can be used to communicate with a peripheral.

### SUMMARY

The inventor recognizes, however, that wireless communication necessarily means that the computer (the device doing the controlling) may be moving or movable relative to the peripheral.

An embodiment discloses detection of characteristics of the communication between the computer and the peripheral. Certain kinds of communication will not be accurate or effective if there is too much movement.

An embodiment discloses carrying out operations with peripherals, and taking actions to determine if the it computer that is using the peripheral is keeping sufficiently still to use the peripheral.

Another embodiment provides information to the computer indicating how long it needs to stay still to complete a task. Another embodiment prevents the task with the peripheral from being started if there is too much movement or communication interruption with the peripheral.

### BRIEF DESCRIPTION OF THE DRAWINGS

FIG. 1 shows a connection between a portable computer such as a PDA, and a wireless peripheral such as a printer

### DETAILED DESCRIPTION

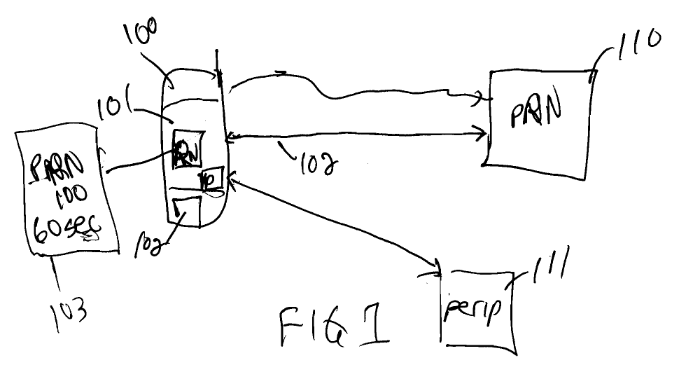

An embodiment is shown in FIG. 1. A wireless capable device, such as a PDA 100, may communicate with a peripheral such as a printer 110. Both of these devices are wireless enabled in this embodiment, meaning that both are capable of communicating wirelessly. For example, the communication may be via wireless USB, or by some other form of communication.

At the moment that the PDA 100 designates a print task, the first object is to find a printer. First, a message stream between the PDA and any communicable peripheral in range may be carried out. For example, this embodiment may have two peripherals 110 and 111 in range of the communication. When preparing to print, an initial screen may be displayed showing peripherals, and whether they are capable of printing. Both may be shown on the screen 101 of the PDA 100. Another embodiment may have previously selected printers, or use a default printer.

Assume the PDA 100 has selected communication with a printer 110, for example based on requesting printing of a document.

A communication 102 is then carried out in which the PDA 100 communicates with the printer 110 about the job that is in the process of being printed. The printer 110 returns a signal which may be indicative of the amount of time that will be necessary to print on the printer 110. This information may include its location and/or its printing capability and/or an amount of time that has been calculated by the peripheral. Based on that signal, the PDA 100 can determine how much data it will need to send to the printer, how long it will take to send that data, and importantly, how long the PDA needs to remain “still” in order to send enough data to print.

PDA 100 may also have a motion detector capability shown as 102a. The motion detector may be GPS, or may be some other analogous form of protecting motion. The peripheral may alternatively detect the motion of the PDA via an amount of variation in the signal that is received by the peripheral.

In one embodiment, the printer icons are shown on the screen only if there is sufficiently small amounts of movement so that the printer can continue receive information from the PDA 100.

Another embodiment uses the data to calculate how long the PDA 100 needs to stay still in order to use the peripheral. Information indicative of this time is displayed on the screen. Message 103 in FIG. 1 shows the printer 110, and shows a 60 second time. This is the time over which the peripheral needs to remain still. This may be shown as a message, and/or sent as a query such as “you will need to stay still for 1 minute, do you want to continue?”.

This time may be displayed, and may count down as the time elapses. For example, it may display “you need to stay still for 60 seconds”. Then, later it may display “you need to stay still for 45 seconds”.

For example, a message may appear in the PDA window that the user is moving too much. Printing may be automatically interrupted, for example, when the user is moving too much. A bookmark function can be used, to attempt to restart printing where it left off when communication was interrupted. There may be numbered sections within the message, and the communication may restart with the next numbered communication part. Pages are not printed until the entire page is received. Part pages may be maintained in memory until the peripheral has received the complete message.

In another embodiment, the peripheral may be a different kind of peripheral, for example it may be a display screen, or television, or audio media player, or the like. These embodiments also take at least one action to warm the user or prevent the user from using the peripheral when there is not a reliable wireless connection, e.g, in the presence of too much movement.

The peripheral may only be displayed if the amount of motion does not exceed that which will be necessary to ensure reliable communication. Alternatively, all peripherals may be displayed, but those which can be used based on current amounts of motion may be indicated with a different icon, or in color, or simply with a text indication that it is, or is not, available. The computer may also display an indication of how long the device needs to be kept still in order to appropriately use the peripheral for the task at hand. Different peripherals may be able to tolerate different amounts of movement, or different times that it is needed to stay still. for example, some peripherals may have diversity antenna structures or larger antennas, to get better reception.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of operations over certain kinds of wireless connections, other kinds of wireless connections can alternatively be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising:
in a computer, communicating with a wireless peripheral; and
displaying information about said wireless peripheral on said computer, including displaying an amount of time that said computer will need to stay in its current area in order to complete a job on said wireless peripheral.

2. A method as in claim 1, further comprising sending data from said computer to said wireless peripheral in order to carry out said job on said wireless peripheral, and updating said amount of time that is displayed, at least a plurality of times while sending said data to said wireless peripheral.

3. A method as in claim 1, further comprising detecting an amount of motion of said computer.

4. A method as in claim 3, further comprising displaying a message when said amount of motion is greater than a specified amount.

5. A method as claim 3, further comprising preventing said job from being started when said amount of motion is greater than a specified amount.

6. A method as in claim 2, further comprising calculating an amount of time necessary to complete said job, and wherein said displaying said amount of time is based on said calculating.

7. A method as in claim 1, further comprising displaying available peripherals on said computer, and indicating those peripherals for which an amount of movement of said computer is excessive.

8. A method comprising:
in a computer, communicating with a wireless peripheral; and
displaying information about said wireless peripheral on said computer, including determining an amount of movement of said computer, determining if said amount of movement is greater than that which will allow a job to be carried out on said peripheral, and displaying information about whether said job can be displayed on said peripheral with a current amount of movement.

9. A method as in claim 8, further comprising displaying data indicating an amount of time that said computer will need to stay in its current area in order to complete a job on said wireless peripheral.

10. A method as in claim 8 further comprising sending data from said computer to said wireless peripheral in order to carry out said job on said wireless peripheral, and updating said amount of time that is displayed, at least a plurality of times while sending said data to said wireless peripheral.

11. A method as in claim 8, further comprising detecting an amount of motion of said computer.

12. A method as in claim 11, further comprising displaying a message when said amount of motion is greater than a specified amount.

13. A method as claim 8, further comprising exchanging messages between said computer and said peripheral indicative of data requirements of a job on said peripheral.

14. A method as in claim 13, further comprising preventing said job from being started when said amount of motion is greater than a specified amount.

15. A wireless peripheral comprising:
a wireless data communication part, that communicates with a remote part, and receives job information over said wireless data communication part;
said wireless data communication part including a data determining part that determines information about an amount of time that will be necessary to carry out a job on said peripheral and communicates said information over said wireless data communication part.

16. A peripheral as in claim 15, wherein said data determining part determines how much of a job has been completed, and sends information indicative of how much of the job has been completed.

17. A peripheral as in claim 15, further comprising detecting an parameter indicative of movement of a sending device, in said peripheral, and sending information indicative of said amount of movement.
